(19) United States
(12) Patent Application Publication
(10) Pub. No.: US 2015/0016899 A1
(43) Pub. Date: Jan. 15, 2015

(54) CUTTING INSERT

(71) Applicant: BOEHLERIT GmbH & Co. KG., Kapfenberg (AT)

(72) Inventor: Walter Baernthaler, St. Marein im Muerztal (AT)

(21) Appl. No.: 14/374,435

(22) PCT Filed: Dec. 28, 2012
(86) PCT No.: PCT/AT2012/050210

§ 371 Date: Jul. 24, 2014

(30) Foreign Application Priority Data
Feb. 1, 2012 (AT) A 50018/2012

(51) Int. Cl. B23G 5/04; B23G 5/20; B23B 27/16; B23G 5/00; B23B 27/06; B23B 27/10

(52) U.S. Cl. CPC B23G 5/04; B23B 27/065; B23B 27/10; B23B 27/1611; B23G 5/005; B23G 5/20; B23G 2200/10; B23G 2200/12; B23G 2240/12
USPC 407/11; 407/113; 407/99

(57) ABSTRACT

The invention relates to a cutting insert (1) for cutting a thread, having a base surface (2), a top surface (3), and lateral surfaces (4, 5, 6, 7) which connect the base surface (2) and the top surface (3) to each other. Multiple cutting teeth (8) which are arranged in a row (33, 34) and which comprise cutting edges (9) are formed on the top surface (3). The top surface (3) has opposing regions (31, 32) which slope downward towards the outside from a center (10) and on each of which a row (33, 34) of cutting teeth is arranged. The regions (31, 32) are rotated relative to one another about an axis (X). In this manner, a cutting insert (1) is provided which can be produced in a simple manner and which has a long service life.

The invention relates to a cutting insert for cutting a thread, having a base surface, a top surface and lateral surfaces, which connect the base surface and the top surface to one another, wherein multiple cutting teeth arranged in a row and comprising cutting edges are formed on the top surface.

Furthermore, the invention relates to a tool for producing a thread on a pipe, having a cassette with insert receptacles or correspondingly formed tool regions for accommodating cutting inserts, wherein a paring insert is arranged in at least one insert receptacle and a cutting insert is arranged in at least one insert receptacle in order to cut the thread.

Pipes for oil-field engineering, in particular for oil drilling, are typically made of austenitic chromium steels. The pipes are embodied respectively with an internal thread at one end and with an external thread at an opposing end so that a line can be created from individual pipes. For this purpose, the external threads are provided with a tapered thread so that a connection which seals within the thread is possible when a connection is made to an internal thread of another pipe.

To create tapered threads on pipes, cutting inserts are used which are embodied with multiple external cutting teeth. The cutting teeth run along a row and, by means of a tool, are guided around a pipe that is to be worked in order to create a thread. The cutting teeth are thereby often arranged on the cutting insert such that a desired taper angle of the tapered thread is set by a displacement of a cutting-insert carrier or, alternatively, of a worked pipe during a working.

Cutting inserts for tools for producing a tapered thread on a pipe are preferably produced from a hard metal, that is, a combination of one or more hard materials such as tungsten carbide and one or more metallic binders such as cobalt, by sintering under pressure. A sintering blank created in such a manner is subsequently worked using a grinding disk during the creation of a final contour.

As mentioned, multiple cutting teeth are arranged in a row on conventional cutting inserts for producing a tapered thread. The cutting teeth thereby rise up from the top surface with varying height, namely with increasing height. The reason for this is that only 0.1 mm to 0.2 mm of material height is to be removed respectively during a material removal, which is why the height of the cutting teeth increases respectively from the first cutting tooth to the last cutting tooth.

With cutting inserts according to the prior art, a service life is limited by a single row of cutting teeth. Similar to how this is known for indexable cutting inserts, it would be desirable to form multiple rows of cutting teeth on a cutting insert so that, when a row of cutting teeth wears, the insert can simply be rotated in order to have another row of cutting teeth available for creating a tapered thread on a pipe on the same cutting insert. This would significantly extend or multiply the service life of a cutting insert. However, the grinding process provided, with which the cutting teeth or the cutting insert must be brought into a usable state after the sintering, argues against a cutting insert embodiment of this type. If a row of cutting teeth is also provided on an opposing side of a row of cutting teeth, a grinding can no longer be used, since a grinding disk that is many times larger than a cutting insert would damage the opposing row or its cutting teeth during the grinding in the case of the necessary conceptual rotation of the rows relative to one another—a cutting tooth with the largest height in a row is across from the cutting tooth with the smallest height of the opposing row.

The object of the invention is to disclose a cutting insert of the type named at the outset which has a long service life and can be produced in a simple manner.

A further object of the invention is to disclose a tool of the type named at the outset which is equipped with a corresponding cutting insert.

The first object of the invention is achieved according to the invention in that, on a cutting insert of the type named at the outset, the top surface comprises opposing regions which slope downwards towards the outside from a center and on each of which a row of cutting teeth is arranged, wherein the regions are rotated relative to one another about an axis.

An advantage achieved by the invention can be seen in that a cutting insert is provided for cutting a, in particular, tapered external thread on a pipe, which insert is embodied in the type of an indexed cutting insert with at least two usable sides. The cutting insert can be created in a simple manner, as opposing regions, in which the rows of cutting teeth are arranged, slope downwards towards the outside from the center and, at the same time, are rotated relative to one another about an axis. In this manner, it is possible that a pre-pressed cutting insert is ground with a significantly larger grinding disk without the opposing row of cutting teeth or recessed regions between the cutting teeth being touched, and thus damaged, during the grinding of a row of cutting teeth. An embodiment, sloping downwards to the outside, of the regions with the cutting teeth is thereby a first measure which ensures that, during a grinding of the top surface or regions between the cutting teeth, a grinding disk can be guided such that the grinding disk travels over the recessed regions on the opposing side of the cutting insert. However, there is still the possibility that the grinding disk touches individual cutting teeth which extend upwards from the top surface. In order to avoid this, it is provided as a second measure that the regions are rotated relative to one another about an axis. A corresponding rotation, possibly in addition to a rotation provided for the creation of a tapered thread, ensures that the cutting teeth are also not damaged during a working by a grinding disk.

The rotation of the individual regions which carry the cutting teeth occurs about an axis that runs perpendicular to the rows of the cutting teeth and runs through the rows.

In respect of a use of the cutting insert as an indexed cutting insert, it is expedient that the regions are rotated by the same absolute angle. A corresponding symmetry of the cutting insert is thus ensured which allows a new row of cutting teeth to be brought into use by a simple turning of the cutting plate by 180° when a row of cutting teeth is no longer fully functional.

The regions are preferably rotated about the axis by an angle of up to 6°, preferably up to 5°. Angles which are this small are usually sufficient to, on the one hand, take a taper angle into account but, on the other hand, to also enable a problem-free working.

The cutting teeth are preferably embodied in each row along the same with a decreasing height. In this manner, an approximately constant material removal can be achieved by each individual cutting tooth.

For reasons of symmetry, it is provided that the cutting teeth of a lesser height of a row are respectively across from the cutting teeth of a greater height of the opposing row. This is expedient if, at a constant height of a material removal per cutting tooth, the cutting insert is to be aligned by a turning by 180°, and it is necessary if the cutting insert is to be embodied as an indexed cutting insert.

The cutting insert can essentially be embodied with any desired perimeter in a top view. For example, it is possible that the cutting insert is embodied as a square cutting insert, wherein a row of cutting teeth is present on each side of the square. In this case, four rows of cutting teeth that are identical are available. A hexagonal or octagonal embodiment having correspondingly six or eight rows of cutting teeth is also possible. However, due to restrictive geometrical conditions it is for many cases sufficient that the cutting insert has lateral surfaces embodied as long sides and lateral surfaces embodied as short sides and that the rows of cutting teeth are arranged on the long sides. Through an embodiment of the cutting insert of this type, which is rectangular in a top view, two rows of cutting-active cutting teeth are created which can be used for a working of a tapered thread. In this context, it can be provided that the lateral surfaces which are embodied as long sides and which connect the base surface and top surface are embodied in a widening manner from the base surface to the top surface in the cross section to the long side. An advantageous machining angle can thus be set at the cutting edges of the cutting teeth in a simple manner. In particular, it can be provided that the corresponding lateral surfaces enclose an angle of 95° to 105°, in particular 98° to 103°, with the base surface.

It can also be provided that the lateral surfaces embodied as short sides and connecting the base surface and top surface are embodied in a tapered manner from the base surface to the top surface in the cross section to the short side. Through an embodiment of this type, it is possible, with a corresponding embodiment of an insert receptacle of a tool, that the cutting insert can be held by means of a clamping retainer alone or also be retained particularly firmly in the insert receptacle, whereby the cutting insert can withstand particularly high cutting forces during use. In this respect, it is preferred that the lateral areas enclose an angle of 78° to 87°, in particular 80° to 84°, with the base surface.

Normally, a cutting insert according to the invention is made of a hard metal and is possibly coated at least in the region of the cutting teeth.

The other object of the invention is achieved by a tool of the type named at the outset which is equipped or fitted with a cutting insert according to the invention.

With a correspondingly embodied tool, the advantages of a cutting insert according to the invention, which were explained above, are fully brought to bear.

It is advantageous if the cutting insert is arranged in the insert receptacle in a tilted manner relative to a longitudinal axis of the tool, preferably at an angle of up to 35°, in particular 15° to 25°. Through the tilted arrangement of the cutting insert, the insert is securely retained in the insert receptacle. On the other hand, not enough pressure is applied to the cutting teeth or their cutting edges for the insert to be released from the insert receptacle.

Particularly with the noted tilted arrangement of the cutting insert, there is the possibility that outlets of coolant channels are arranged in the cassette or the tool on both sides of the rows of cutting teeth. It is thus possible that, from two directions roughly parallel to the cutting edges, coolant is applied to the respective cutting-active row of cutting teeth so that an effective cooling is ensured. This can increase a service life of the cutting insert.

Additional features, advantages and effects of the invention follow from the exemplary embodiment described below. The drawings which are thereby referenced show the following:

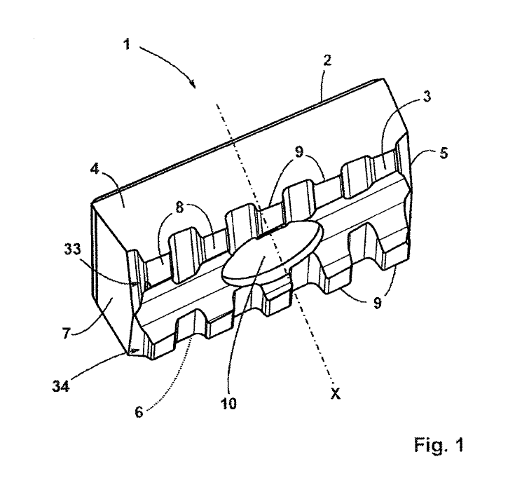

FIG. 1 A cutting insert according to the invention;

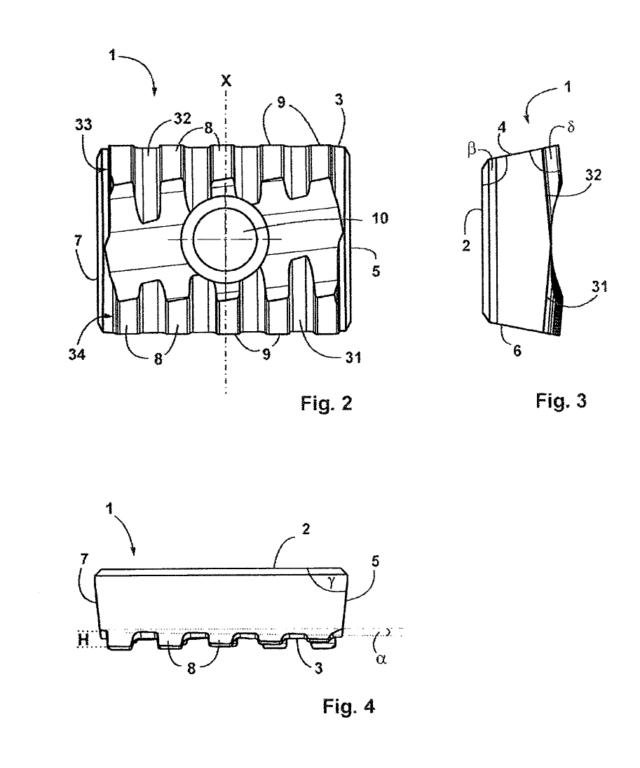

FIG. 2 A cutting insert according to the invention according to FIG. 1 in a top view;

FIG. 3 A cutting insert according to the invention in a side view;

FIG. 4 A cutting insert according to the invention in a front-face view;

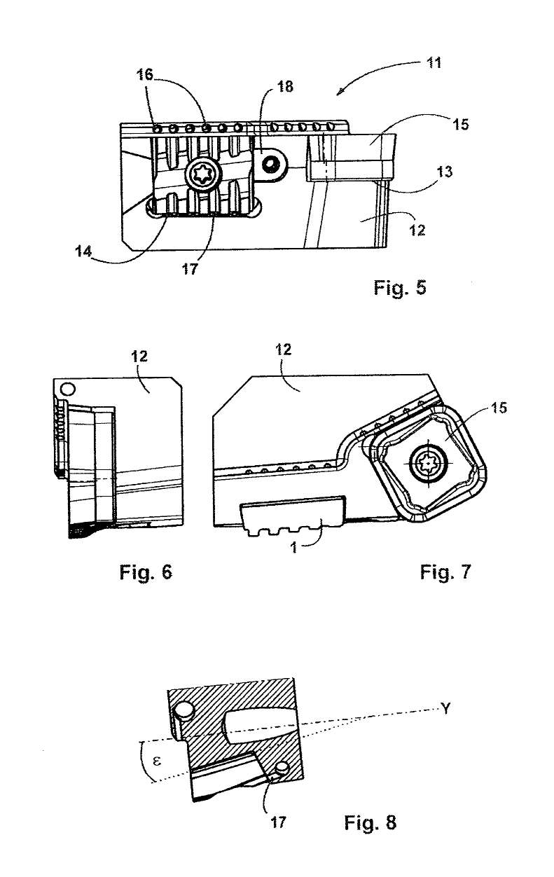

FIG. 5 A cassette with a cutting insert according to the invention;

FIG. 6 A side view of the cassette according to FIG. 5;

FIG. 7 A top view of the cassette according to FIG. 5;

FIG. 8 A partial cross section through the cassette according to FIG. 5.

In FIGS. 1 through 4, a cutting insert according to the invention is illustrated in different views. In FIG. 1, the cutting insert 1 is shown in a perspective representation. The cutting insert 1 has a base surface 2 and a top surface 3, which are connected by lateral surfaces 4, 5, 6, 7. As can be seen from FIGS. 2 through 4, the base surface 2 is embodied in a flat manner. A short beveled region first extends from the base surface 2, which region turns into the remaining regions of the lateral surfaces 4, 5, 6, 7 that essentially define or determine the lateral surfaces 4, 5, 6, 7. The cutting insert 1 is embodied rectangularly in a top view, though other forms are also possible, for example, a square embodiment. The lateral surfaces 4, 6 are arranged on long sides of the cutting insert 1, which surfaces become wider from the base surface 2 to the top surface 3, as can be seen particularly in FIG. 3, wherein the lateral surfaces 4, 6 enclose an angle β of approximately 100° with the base surface 2. Like the lateral surfaces 4, 6 arranged on the long sides, the shorter lateral surfaces 5, 7 arranged on short sides 5, 7 are embodied in a flat manner, but taper in the cross section from the base surface 2 to the top surface 3 so that, in a front-face view of the long sides, the cutting insert 1 has a roughly trapezoidal shape. The lateral surfaces 5, 7 thereby enclose an angle γ of approximately 82° with the base surface 2.

Two opposing regions 31, 32 are provided on the top surface 3, which regions slope downwards from a center 10 towards the lateral sides 4, 6 arranged on the long sides, which can particularly be seen from FIG. 3. As in the present case, the center 10 can be penetrated by an opening for an attachment element, although this is not mandatory if the cutting insert 1 is attached in a different manner than by using an attachment element which penetrates the cutting insert I, for example, a clamping holder. The regions 31, 32 respectively carry a row 33, 34 of cutting teeth 8 with front-face cutting edges 9. In the exemplary embodiment, the two rows 33, 34 have respectively five cutting teeth 8, although the number of cutting teeth 8 can vary, for example, within the range of three to nine cutting teeth 8. In each row 33, 34 the cutting teeth 8 are embodied with a height H which increases along the respective row 33, 34. With the varying height H, it is taken into account that a maximum material removal can be 0.1 mm to 0.2 mm per material removal. According to FIG. 1 or FIG. 4, the two rows 33, 34 of cutting teeth 8 are, on the one hand, thereby tilted towards the base surface 2 about an axis X by an angle α of the same amount but are tilted in different rotational directions. On the other hand, the rows 33, 34 are arranged on the regions 31, 32 which slope downwards towards the outside. It is thus ensured that the recessed regions located between the cutting teeth 8 can be ground without problems or that a grinding disk can move freely during the working of a row 33, 34 without the respective opposing row 33, 34 or the cutting teeth 8 thereof or the recessed regions lying therebetween being damaged.

The cutting teeth 8 are shaped such that their surfaces at the head, which form the flanks in the cutting insert, roughly enclose an angle δ of 85° to 95°; preferably approximately 90°, with the lateral surfaces 4, 6, as this can be seen from FIG. 3.

In FIGS. 5 through 8, a cassette 12 of a tool 11 is illustrated. The tool 11 normally comprises multiple cassettes 12 of this type, which respectively have a front-face insert receptacle 13 and a second insert receptacle 14 arranged after it in a longitudinal direction. A paring insert 15 is held in the insert receptacle 13, while a cutting insert 1 according to the invention is held in the insert receptacle 14 in that an attachment element is guided through the central opening penetrating the cutting insert 1 and is secured in the cassette 12. Essentially, both the paring insert 15 and also the cutting insert 1 can be directly attached to the tool 11, or the cassette 12 can be omitted completely.

The cassette 12 is embodied in a top view according to FIG. 7 such that the insert receptacle 14 for the cutting insert 1 is embodied in a roughly trapezoidal manner like the insert. It is thus possible that the cutting insert 1 is firmly held in the insert receptacle 14, even if high cutting forces occur. The cutting insert can thereby also be secured against a detachment with a clamping retainer 18.

The cutting insert 1 is arranged or pitched in the insert receptacle 14 in a tilted manner such that an angle ε is approximately 15° to 25° in relation to a longitudinal axis Y of the tool 11. A suitable cutting performance is thus possible while simultaneously avoiding a detachment of the cutting insert 1 or an exceedingly high loading of the same. In addition, coolant channels 16, 17 are provided in the cassette 12 or, alternatively, directly in the tool. First coolant channels 16 end above the cutting teeth 8 in active cutting use or the cutting edges 9 of the same. Due to the embodiment according to the invention of the cutting insert 1 and the slanted pitch or attachment of the same in the insert receptacle 14, outlets of second coolant channels 17 can also be provided on the underside or the non-cutting-active cutting teeth 8. With this embodiment, it is possible that coolant is applied to the cutting edges 9 or the cutting teeth 8 in the active cutting region from two directions, each approximately at a right angle, which results in an effective cooling and therefore to an extension of the service life of the cutting insert 1.

1. Cutting insert (1) for cutting a thread, having a base surface (2), a top surface (3) and lateral surfaces (4, 5, 6, 7), which connect the base surface (2) and the top surface (3) to one another, wherein multiple cutting teeth (8) arranged in a row (33, 34) and comprising cutting edges (9) are formed on the top surface (3), characterized in that the top surface (3) comprises opposing regions (31, 32) which slope downwards towards the outside from a center (10) and on each of which a row (33, 34) of cutting teeth (8) is arranged, wherein the regions (31, 32) are rotated relative to one another about an axis (X).

2. Cutting Cutting insert (1) according to claim 1, characterized in that the regions (31, 32) are rotated about an axis (X) that runs perpendicular to the rows (33, 34) of the cutting teeth (8) and runs through the rows.

3. Cutting Cutting insert (1) according to claim 1, characterized in that the regions (31, 32) are rotated by the same absolute angle (α).

4. Cutting Cutting insert (1) according to claim 1, characterized in that the regions (31, 32) are rotated about the axis (X) by an angle (α) of up to 6°, preferably up to 5°.

5. Cutting Cutting insert (1) according to claim 1, characterized in that the cutting teeth (8) in each row (33, 34) are formed along the same with decreasing height (H).

6. Cutting Cutting insert (1) according to claim 1, characterized in that the cutting teeth (8) of a lesser height (H) of a row (33, 34) are respectively across from the cutting teeth (8) of a greater height (H) of the opposing row (33, 34).

7. Cutting Cutting insert (1) according to claim 1, characterized in that the cutting insert (1) has lateral surfaces (4, 6) embodied as long sides and lateral surfaces (5, 7) embodied as short sides and in that the rows (33, 34) of cutting teeth (8) are arranged on the long sides.

8. Cutting Cutting insert (1) according to claim 7, characterized in that the lateral surfaces (4, 6) which are embodied as long sides and which connect the base surface (2) and top surface (3) are embodied in a widening manner from the base surface (2) to the top surface (3) in the cross section to the long side.

9. Cutting Cutting insert (1) according to claim 8, characterized in that the lateral surfaces (4, 6) enclose an angle (β) of 95° to 105°, in particular 98° to 103°, with the base surface (2).

10. Cutting Cutting insert (1) according to claim 7, characterized in that the lateral surfaces (5, 7) which are embodied as short sides and which connect the base surface (2) and top surface (3) are embodied in a tapered manner from the base surface (2) to the top surface (3) in the cross section to the short side.

11. Cutting Cutting insert (1) according to claim 10, characterized in that the lateral surfaces (5, 7) enclose an angle (γ) of 78° to 87°, in particular 80° to 84°, with the base surface (2).

12. Cutting Cutting insert (1) according to claim 1, characterized in that the cutting insert (1) is made of hard metal and is possibly coated at least in the region of the cutting teeth (8).

13. Cutting Tool (11) for producing a thread on a pipe, having a cassette (12) with insert receptacles (13, 14) or correspondingly formed tool regions for accommodating cutting inserts (1), wherein a paring insert (15) is arranged in at least one insert receptacle (13) and a cutting insert (1) is arranged in at least one insert receptacle (14) in order to cut the thread, characterized in that the cutting insert (1) is embodied according to claim 1.

14. Cutting Tool (11) according to claim 13, characterized in that the cutting insert (1) is arranged in the insert receptacle (14) in a tilted manner relative to a longitudinal axis (Y) of the tool (11), preferably at an angle (ε) of up to 35°, in particular 15° to 25°.

15. Cutting Tool (11) according to claim 13, characterized in that outlets of coolant channels (16) are arranged in the cassette (12) or the tool (11) on both sides of the rows (33, 34) of cutting teeth (8).
